(19) United States
(12) Patent Application Publication
(10) Pub. No.: US 2014/0310587 A1
(43) Pub. Date: Oct. 16, 2014

(54) APPARATUS AND METHOD FOR PROCESSING ADDITIONAL MEDIA INFORMATION

(71) Applicant: ELECTRONICS AND TELECOMMUNICATIONS RESEARCH INSTITUTE, Daejeon (KR)

(72) Inventors: Hyun Woo OH, Daejeon (KR); Ji Yeon KIM, Daejeon (KR); Deock Gu JEE, Beijing (CN); Jae Kwan YUN, Daejeon (KR); Jong Hyun JANG, Daejeon (KR); Kwang Roh PARK, Daejeon (KR)

(73) Assignee: ELECTRONICS AND TELECOMMUNICATIONS RESEARCH INSTITUTE, Daejeon (KR)

(21) Appl. No.: 14/253,193

(22) Filed: Apr. 15, 2014

(30) Foreign Application Priority Data
Apr. 16, 2013 (KR) 10-2013-0041407

(51) Int. Cl. G06F 17/24

(52) U.S. Cl. CPC G06F 17/241
USPC 715/233

(57) ABSTRACT

Disclosed is an apparatus and a method for processing additional media information, including an acquisition unit to acquire, from a database, when media data is input through an interface, a pattern corresponding to the input media data and a processor to determine a sensory effect corresponding to the acquired pattern and generate a first annotation of the determined sensory effect.

### CROSS-REFERENCE TO RELATED APPLICATION

This application claims the priority benefit of Korean Patent Application No. 10-2013-0041407, filed on Apr. 16, 2013, in the Korean Intellectual Property Office, the disclosure of which is incorporated herein by reference.

### BACKGROUND

1. Field of the Invention

The present invention relates to technology for generating an annotation of a sensory effect while filming a video and generating sensory effect metadata based on a result obtained by analyzing an annotation in the media.

2. Description of the Related Art

Demands for higher resolutions by users of a media service, for example, a standard definition (SD) level to a high definition (HD) level and HD to a full HD level, and for interactive watching or sensory experiences have been increasing.

In order to provide a sensory experience media service, existing media is being converted to sensory experience media to which a sensory experience effect is added. As a consequence, technology for adding sensory effect metadata is required for the conversion.

Use of conventional technology for adding the sensory effect metadata may be inconvenient because a frame to which a sensory effect is added is manually selected using an authoring tool, and a process of adding and editing the sensory effect to the selected frame is performed repeatedly.

Accordingly, there is a desire for a technology for automatically generating media-based sensory effect metadata without an addition of a sensory effect while filming a video, and generating sensory experience media more easily and conveniently.

### SUMMARY

In a case of adding sensory effect metadata to media and generating sensory experience based media to provide a sensory experience media service, the present invention provides a method of generating an annotation of to a sensory effect to enable a user to add the sensory experience metadata faster and more easily and conveniently, and a method of generating the sensory effect metadata based on the generated annotation.

The present invention provides a method of automatically generating an annotation of a sensory effect in a frame to which the sensory effect is to be added while filming a video and a method of automatically generating sensory effect metadata based on the annotation in media. Thus, the methods may enable an easier generation of sensory experience media contents and improve an issue of manual authoring using an authoring tool, which is involved in the authoring of existing sensory experience media, and a shortage of sensory experience media contents.

According to an aspect of the present invention, there is provided an additional media information processing apparatus, including an acquisition unit to acquire, from a database (DB), when media data is input through an interface, a pattern corresponding to the input media data, and a processor to determine a sensory effect corresponding to the acquired pattern and generate a first annotation of the determined sensory effect.

According to another aspect of the present invention, there is provided a method of processing additional media information, including acquiring, when media data is input through an interface, a pattern corresponding to the input media data from a DB, and determining a sensory effect corresponding to the acquired pattern and generating a first annotation of the determined sensory effect.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of an additional media information processing apparatus according to an embodiment of the present invention;

FIG. 2 is a diagram illustrating a configuration of an additional media information processing apparatus according to another embodiment of the present invention;

FIG. 3 is a diagram illustrating a configuration of an additional media information processing apparatus according to still another embodiment of the present invention;

FIG. 4 is a diagram illustrating a method of generating an annotation of a sensory effect in an additional media information processing apparatus according to an embodiment of the present invention;

FIG. 5 is a diagram illustrating a method of generating sensory effect metadata in an additional media information processing apparatus according to an embodiment of the present invention;

FIG. 6 is a diagram illustrating an application of an annotation of a sensory effect provided by an additional media information processing apparatus according to an embodiment of the present invention;

FIG. 7 is a flowchart illustrating a method of processing additional media information according to an embodiment of the present invention; and

FIG. 8 is a flowchart illustrating a method of processing additional media information according to another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the accompanying drawings, however, the present invention is not limited thereto or restricted thereby.

When it is determined a detailed description related to a related known function or configuration that may make the purpose of the present invention unnecessarily ambiguous in describing the present invention, the detailed description will be omitted. Also, terminology used herein is defined to appropriately describe the exemplary embodiments of the present invention and thus may be changed depending on a user, the intent of an operator, or a custom. Accordingly, the terminology must be defined based on the following overall description of this specification.

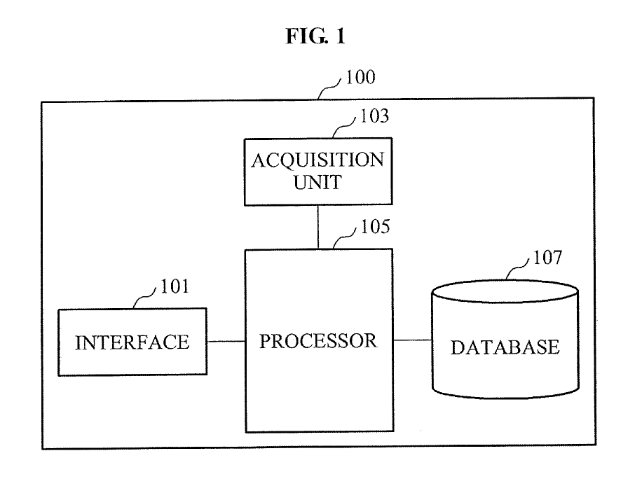

FIG. 1 is a diagram illustrating a configuration of an additional media information processing apparatus 100 according to an embodiment of the present invention.

Referring to FIG. 1, the additional media information processing apparatus 100 may include an interface 101, and acquisition unit 103, a processor 105, and a database (DB) 107.

The interface 101 may receive media data. Here, the interface 101 may be one of a motion recognition interface, a voice recognition interface, an environment sensor interface, an authoring tool interface, a media playback interface, and an automatic media based sensory effect (MSE) extraction interface.

When media data is input through the interface 101, the acquisition unit 103 may acquire, from the DB 107, a pattern, for example, a motion and/or gesture pattern, a voice pattern, a sensor data pattern, an effect attribute pattern, and the like, corresponding to the input media data. The acquisition unit 103 may verify whether a second annotation of a sensory effect is present in the media data. When the acquisition unit 103 verifies that the second annotation is present in the media data, the acquisition unit 103 may extract the second annotation from the media data.

The processor 105 may determine a sensory effect corresponding to the acquired pattern and generate a first annotation of the determined sensory effect. Here, the processor 105 may determine a type of the first annotation to be one of a text annotation, a free text annotation, a structured annotation, an image annotation, and a voice annotation, and generate the first annotation based on the determined type.

The processor 105 may determine a position of a frame in the media data at which the first annotation is to be recorded and generate the first annotation based on the determined position.

Also, when the second annotation is extracted from the media data using the acquisition unit 103, the processor 105 may analyze a sensory effect corresponding to the extracted second annotation and generate sensory effect metadata using an attribute value of the analyzed sensory effect. Here, the processor 105 may analyze a type of the extracted second annotation and analyze the sensory effect based on the analyzed type of the second annotation.

The DB 107 may store a pattern based on the media data.

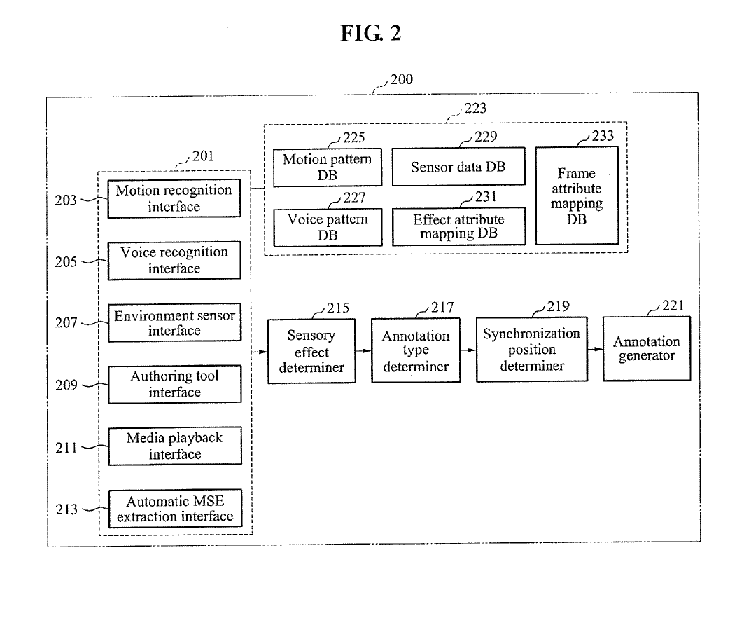

FIG. 2 is a diagram illustrating a configuration of an additional media information processing apparatus 200 according to another embodiment of the present invention.

Referring to FIG. 2, the additional media information processing apparatus 200 may generate an annotation of a sensory effect in a frame to which the sensory effect may be added at a point in time during filming of a video or a process of editing media content.

The additional media information processing apparatus 200 may perform mapping on a pattern stored in a DB 223 based on data input through an interface 201, determine a sensory effect corresponding to the mapped pattern, and generate an annotation of the determined sensory effect.

The additional media information processing apparatus 200 may include the interface 201, a sensory effect determiner 215, an annotation type determiner 217, a synchronization position determiner 219, an annotation generator 221, and the DB 223.

The interface 201 may include at least one of a motion recognition interface 203, a voice recognition interface 205, an environment sensor interface 207, an authoring tool interface 209, a media playback interface 211, and an automatic MSE extraction interface 213.

The motion recognition interface 203 may receive a motion of a human being or a gesture of a hand, a head, and the like, through recognition performed using a camera. Here, the motion recognition interface 203 may conduct a search of a motion pattern DB 225, perform a mapping on a pattern of the received motion or gesture, and recognize the motion or gesture.

For example, when camera images are being filmed through a smart terminal, the voice recognition interface 205 may receive a voice signal. In this example, the voice recognition interface 205 may receive the voice signal such as “the wind is blowing at a speed of 40 m/s and it is raining heavily,” “wild wind,” or “heavy rain” while filming “an amount of wind and rain generated under an influence of a typhoon” through the smart terminal. The voice recognition interface 205 may recognize a voice pattern, a word, a sentence, and the like based on the input voice signal. Also, the voice recognition interface 205 may analyze the voice pattern based on the input voice signal and human emotions. Here, the voice pattern analyzed based on the emotions may be used as basic data, for example, when generating an annotation to generate lighting effect metadata.

Here, the voice recognition interface 205 may conduct a search of a voice pattern DB 227 and recognize the voice pattern, the word, and the sentence by performing pattern matching on the input voice signal.

When data of coordinate values having continuity is extracted as valid data, the environment sensor interface 207 may convert the data to a motion sensory effect, for example, a motion effect that may move a chair providing a four-dimensional effect.

The environment sensor interface 207 may receive sensing data from a sensor to detect, for example, temperature, humidity, illuminance, acceleration, angular speed, rotation, Global Positioning System (GPS) information, gas, and wind. Through the extraction of the valid data, the environment sensor interface 207 may eliminate unnecessary data from the data received from the sensor, extract the valid data, refer to a sensor data pattern DB 229, and convert the extracted valid data through a sensor effect determination.

For example, the environment sensor interface 207 may eliminate unnecessary data from data received from a 3 axis gyrosensor and determine whether a state is at rest or in motion. Here, when the data received from a 3 axis gyrosensor from which unnecessary data is eliminated does not exceed a threshold, the environment sensor interface 207 may determine the state to be at rest without a motion. Conversely, when the data exceeds the threshold, the environment sensor interface 207 may determine the state to be in motion with orientation.

The authoring tool interface 209 may select, from a filmed video or an edited video, a frame to which a sensory effect is to be added, and allow the sensory effect to last for a desired amount of time. Here, the authoring tool interface 209 may analyze a position of the frame and a duration over which the sensory effect lasts. Here, the authoring tool interface 209 may further analyze attribute information corresponding to a sensory effect. In a case of a wind effect, the authoring tool interface 209 may analyze the attribute information on wind. For example, a wind blowing at a speed of less than 4 m/s may be analyzed to be a weak wind and a wind blowing at a speed of greater than or equal to 14 m/s may be analyzed to be a strong wind.

The authoring tool interface 209 may conduct a search of an effect attribute mapping DB 231 and determine the attribute information corresponding to the sensory effect.

When a media content previously filmed and edited is played by an authoring tool or a terminal, the media playback interface 211 may capture a frame to which a sensory effect is to be added. When an image capture event occurs, the media playback interface 211 may extract a feature point of the captured frame. Here, the media playback interface 211 may extract the feature point of the frame by comparing and analyzing a preceding frame and a frame subsequent to the captured frame.

Also, the media playback interface 211 may analyze an attribute of the frame based on the extracted feature point. For example, the media play interface 211 may classify an object showing numerous motions and a background showing zero or few motions. Here, the media playback interface 211 may find an approximate size, a shape, or a number of objects or backgrounds. The media playback interface 211 may conduct a search of a frame attribute mapping DB 233 and analyze a frame attribute corresponding to the feature point of the frame.

The automatic MSE extraction interface 213 may automatically extract, using an automatic MSE extraction technology, a sensory effect based on media. Here, the automatic MSE extraction technology may include an automatic object-based motion effect MSE extraction and an automatic viewpoint-based motion effect MSE extraction. Through the automatic object-based motion effect MSE extraction, a motion effect and a sensory effect including a lighting effect may be automatically extracted. In a case of an automatic motion effect extraction, an object may be extracted, a motion of the object may be traced, and the motion of the object may be mapped to the motion effect. Also, in a case of an automatic lighting effect extraction, the lighting effect may be mapped based on a change of Red, Green, Blue (RGB) colors in a certain portion of a frame.

Through the automatic viewpoint-based motion effect MSE extraction, a movement of a display may be traced based on a camera viewpoint and a change of the camera viewpoint may be mapped to the motion effect.

The automatic MSE extraction interface 213 may receive an automatic object-based motion effect MSE extraction event based on information associated with a start and an end of a frame, and automatically extract multiple objects based on extracting and analyzing the feature point of the frame. The automatic MSE extraction interface 213 may automatically extract an object showing numerous motions to be one of the multiple objects.

The automatic MSE extraction interface 213 may trace a motion of an individual object of the automatically extracted multiple objects, extract data on the motion, extract valid data from the extracted data on the motion, and convert the extracted valid data through a sensory effect determination.

For example, the automatic MSE extraction interface 213 may apply the automatic viewpoint-based motion effect MSE extraction to a video of a subject in which an entire display moves up, down, left, and right, similar to an effect of riding a rollercoaster, and automatically select a viewpoint area of interest to extract the feature point of the motion. The automatic MSE extraction interface 213 may analyze the motion by selecting the area and thus, produce a relatively small reduction in an amount of time for calculation compared to analyzing a motion in an entire area of the frame. The automatic MSE extraction interface 213 may select five areas in a fixed manner, for example, upper and lower areas on the left, center, and upper and lower areas on the right. Also, the automatic MSE extraction interface 213 may select the area crosswise, for example, upper and lower areas at the center, the center, and left and right areas at the center.

When the viewpoint area is selected, the automatic MSE extraction interface 213 may extract the feature point from the viewpoint area and extract a motion vector based on the motion of the feature point in the area. Here, the automatic MSE extraction interface 213 may calculate the motion vector based on the sum of vectors of feature points and on the average of the vectors, or correct the motion vector by applying a weight of the motion vector to clarify the motion effect. Here, the automatic MSE extraction interface 213 may calculate the motion vector by applying a greater weight on a vector having a greater value toward an identical direction from the average than the average. The automatic MSE extraction interface 213 may expand a value for which a motion vector weight correction is completed in an individual area of interest to an entire area, set the value as a representative value of a motion value of an entire frame, and convert the motion value of the entire frame through sensory effect datamation.

In a case of an automatic lighting effect MSE extraction, the automatic MSE extraction interface 213 may automatically select an area having a brightest feature point and an area having numerous changes of the feature point to be a light area. The automatic MSE extraction interface 213 may extract an RGB value from the selected light area. The automatic MSE extraction interface 213 may correct the RGB value by applying a weight to an RGB value having a great change.

The sensory effect determiner 215 may determine which sensory effect may be allowed for data, for example, a motion, a gesture, a voice pattern, a word, and a sentence, inputted through the interface 201. For example, when the motion recognition interface 203 recognizes a gesture of raising a right hand turning the hand as a motion of rotation, the sensory effect determiner 215 may determine a windmill effect to be a sensory effect that may be provided through the rotation.

The annotation type determiner 217 may determine a type of an annotation of a sensory effect. Here, the annotation type determiner 217 may determine the type of the annotation to be one of a text annotation, a free text annotation, a structured annotation, an image annotation, and a voice annotation. For example, the text annotation may refer to an annotation in a faun of a word, for example, “wind,” “water,” and “vibration.” The free text annotation may refer to an annotation represented in a form of a sentence, for example, “the hero is exposed to wind through an open a car window.” The structured annotation may refer to an annotation described as per a five Ws and one H rule. The image annotation may refer to an annotation as a captured image of a media frame. Also, the voice annotation may refer to an annotation recorded by a voice signal.

When a voice pattern, a word, and a sentence are recognized from the voice signal through the voice recognition interface 205, the annotation type determiner 217 may determine the type to be one of the voice annotation based on the voice pattern, the text annotation based on word recognition, and the free text annotation based on sentence recognition.

The synchronization position determiner 219 may determine a synchronization position to designate a position at which an annotation is recorded.

The annotation generator 221 may generate an annotation of a sensory effect based on the determined type of annotation and the determined synchronization position.

The DB 223 may include a motion pattern DB 225, the voice pattern DB 227, the sensor data pattern DB 229, the effect attribute mapping DB 231, and the frame attribute mapping DB 233.

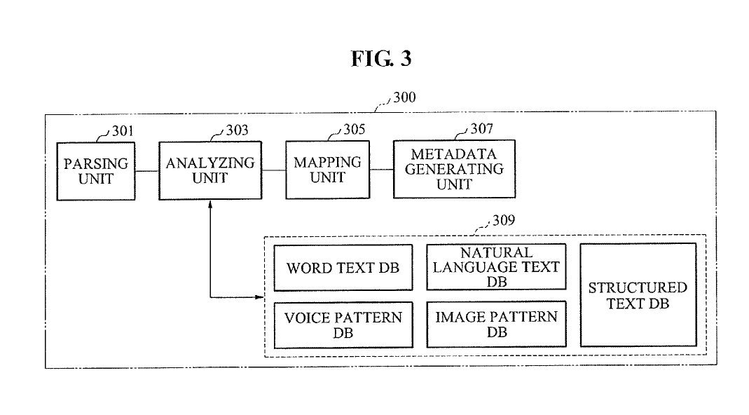

FIG. 3 is a diagram illustrating a configuration of an additional media information processing apparatus 300 according to still another embodiment of the present invention.

Referring to FIG. 3, the additional media information processing apparatus 300 may generate sensory effect metadata based on media to which an annotation of a sensory effect is added.

The additional media information processing apparatus 300 may include a parsing unit 301, an analyzing unit 303, a mapping unit 305, a metadata generating unit 307, and a DB 309.

When media to which an annotation of a sensory effect is added is input, the parsing unit 301 may parse the annotation from the media.

The analyzing unit 303 may analyze the parsed annotation while performing a process contrasting a process of generating the annotation of the sensory effect. Here, the analyzing unit 303 may refer to the DB 309 and analyze a type of the annotation. The analyzing unit 303 may analyze one type of annotation among a text annotation, a free text annotation, a structured annotation, an image annotation, and a voice annotation.

The mapping unit 305 may find mapping information on the sensory effect based on the analyzing of the annotation.

The metadata generating unit 307 may generate sensory effect metadata.

The DB 309 may include a word text DB, a natural language text DB, a voice pattern DB, an image pattern DB, and a structured text DB.

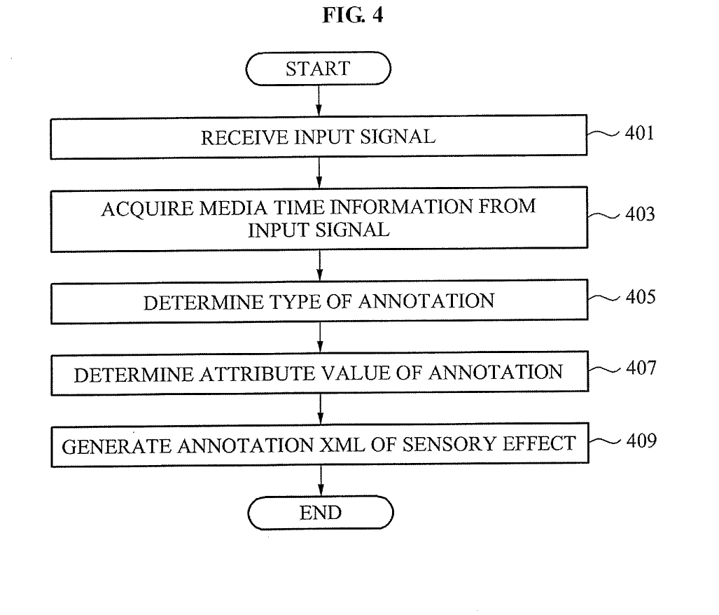

FIG. 4 is a diagram illustrating a method of generating an annotation of a sensory effect in an additional media information processing apparatus according to an embodiment of the present invention.

Referring to FIG. 4, in operation 401, the additional media information processing apparatus may receive an input signal from an interface, for example, an authoring tool interface, a voice recognition interface, a motion recognition interface, an environment sensor interface, and an automatic MSE extraction interface, which provide an annotation generating event, and an interface regarding an image capture event

In operation 403, the additional media information processing apparatus may acquire media time information from the input signal.

In operation 405, the additional media information processing apparatus may determine a type of an annotation associated with the input signal by referring to a DB.

In operation 407, the additional media information processing apparatus may determine an attribute value of the annotation.

In operation 409, the additional media information processing apparatus may generate an annotation eXtensible Markup Language (XML) of a sensory effect based on the acquired media time information, the determined type of the annotation, and the determined attribute value of the annotation.

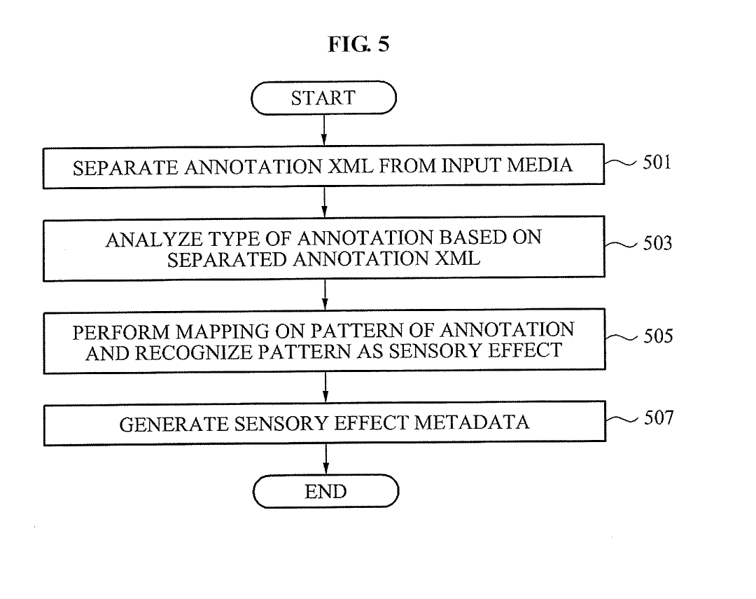

FIG. 5 is a diagram illustrating a method of generating sensory effect metadata in an additional media information processing apparatus according to an embodiment of the present invention.

Referring to FIG. 5, in operation 501, the additional media information processing apparatus may receive media to which an annotation of a sensory effect is added and separate an annotation XML from the input media.

In operation 503, the additional media information processing apparatus may analyze a type of the annotation by referring to a DB on the separated annotation XML.

In operation 505, the additional media information processing apparatus may perform mapping on a pattern of the annotation, receive the pattern as a sensory effect, and end a process of parsing the annotation from media.

In operation 507, the additional media information processing apparatus may generate the sensory effect metadata by mapping the sensory effect recognized based on the annotation and determining a default attribute value of the sensory effect.

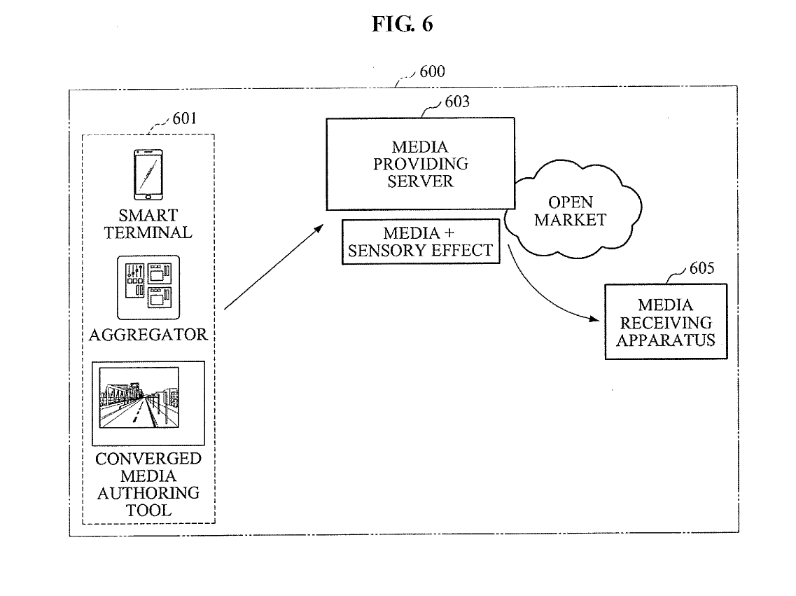

FIG. 6 is a diagram illustrating an application of an annotation of a sensory effect provided by an additional media information processing apparatus 600 according to an embodiment of the present invention.

Referring to FIG. 6, the additional media information processing system 600 may include an additional media information processing apparatus 601, a media providing server 603, and a media receiving apparatus 605.

The additional media information processing apparatus 601 may be, for example, a smart terminal, an aggregator, and a converged media authoring tool. The additional media information processing apparatus 601 may generate an annotation of a sensory effect and provide the annotation to the media providing server 603.

The smart terminal may generate the annotation of the sensory effect through a voice interface or generate the annotation of the sensory effect through a Graphical User Interface (GUI) on a display while filming a video using a camera.

The aggregator may refer to an apparatus provided with a sensor used to detect temperature, humidity, illuminance, acceleration, angular speed, GPS information, gas, wind, and the like, and generate the annotation of the sensory effect based on an environment sensor.

The converged media authoring tool may provide a function of editing the filmed media content or editing the sensory effect manually, and generate the annotation of the sensory effect through an authoring tool interface.

The media providing server 603 may receive the annotation of the sensory effect from the additional media information processing apparatus 601 and provide, through an open market site, metadata provided with the received annotation-based sensory effect and the media content to the media receiving apparatus 605.

The media receiving apparatus 605 may access the open market site, search for and download the metadata and the media content to which the sensory effect is added, and enable a user, for example, a provider of a sensory effect media service, an apparatus manufacturer, a media provider, a general user, to use the sensory experience media service more easily and conveniently.

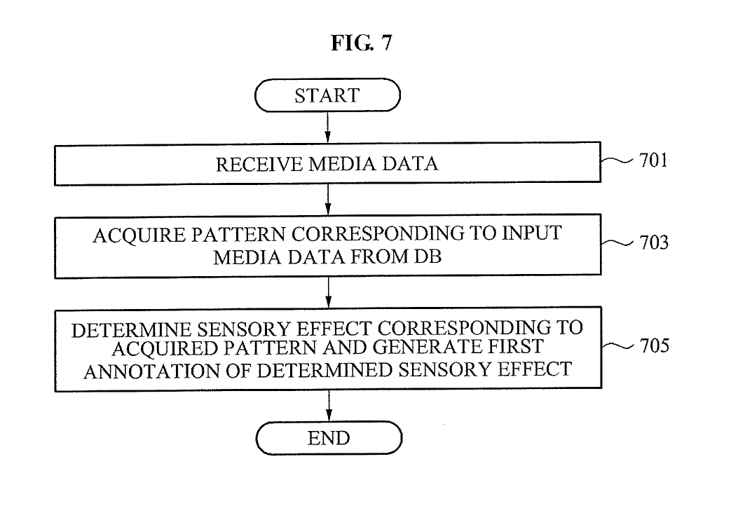

FIG. 7 is a flowchart illustrating a method of processing additional media information according to an embodiment of the present invention.

Referring to FIG. 7, in operation 701, an additional media information processing apparatus may receive media data through an interface. Here, the additional media information processing apparatus may receive the media data through one interface among a motion recognition interface, a voice recognition interface, an environment sensor interface, an authoring tool interface, a media playback interface, and an automatic MSE extraction interface.

In operation 703, the additional media information processing apparatus may acquire, from a DB, a pattern corresponding to the input media data.

In operation 705, the additional media information processing apparatus may determine a sensory effect corresponding to the acquired pattern and generate a first annotation of the determined sensory effect.

Here, the additional media information processing apparatus may determine a type of the first annotation to be one of a text annotation, a free text annotation, a structured annotation, an image annotation, and a voice annotation, and generate the first annotation based on the determined type.

Also, the additional media information processing apparatus may determine a position of a frame in the media data to which the first annotation is added and generate the first annotation based on the determined position.

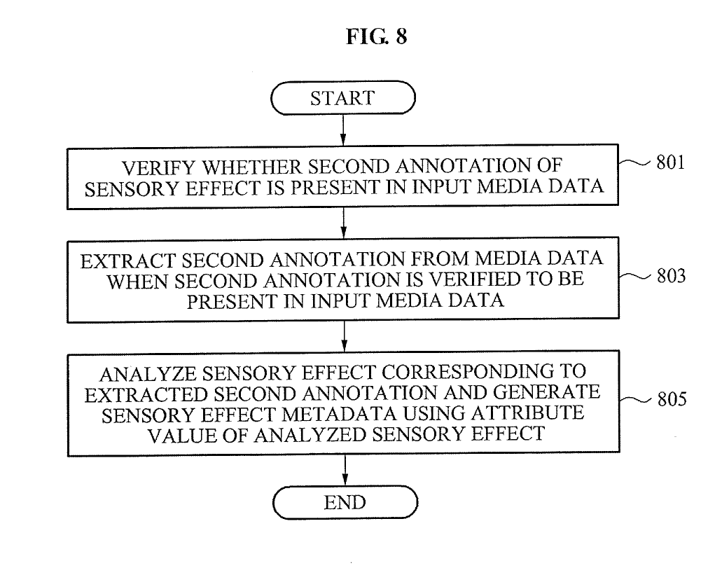

FIG. 8 is a flowchart a illustrating a method of processing additional media information according to another embodiment of the present invention.

Referring to FIG. 8, in operation 801, an additional media information processing apparatus may receive media data and verify whether a second annotation of a sensory effect is added to the input media data.

In operation 803, when the additional media information processing apparatus verifies that the second annotation is added to the media data, the additional media information processing apparatus may extract the second annotation from the media data.

In operation 805, the additional media information processing apparatus may analyze a sensory effect corresponding to the extracted second annotation and generate sensory effect metadata using an attribute value of the analyzed sensory effect. Here, the additional media information processing apparatus may analyze a type of the extracted second annotation and analyze the sensory effect based on the analyzed type of the second annotation.

According to an embodiment of the present invention, in a case of adding sensory effect metadata to media and generating sensory experience-based media to provide a sensory experience media service, a method of generating an annotation of a sensory effect to enable a user to add the sensory effect metadata faster and more easily and conveniently, and a method of generating the sensory effect metadata based on the generated annotation are provided.

According to an embodiment of the present invention, a method of automatically generating an annotation of a sensory effect in a frame to which the sensory effect may be added while filming a video and a method of automatically generating sensory effect metadata based on the annotation of the sensory effect added to media may facilitate generation of sensory experience media contents and resolve issues of manual authoring using an authoring tool involved in existing sensory experience media authoring and a shortage of the sensory experience media contents.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device. Examples of the non-transitory computer readable recording medium include read-only memory (ROM), random-access memory (RAM), CD-ROMs, magnetic tapes, floppy discs, optical data storage devices. Also, functional programs, codes, and code segments that accomplish the examples disclosed herein can be easily construed by programmers skilled in the art to which the examples pertain based on and using the flow diagrams and block diagrams of the figures and their corresponding descriptions as provided herein.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An additional media information processing apparatus, the apparatus comprising:
an acquisition unit to acquire, from a database, when media data is input through an interface, a pattern corresponding to the input media data; and
a processor to determine a sensory effect corresponding to the acquired pattern and generate a first annotation of the determined sensory effect.

2. The apparatus of claim 1, wherein the processor determines a type of the first annotation to be one of a text annotation, a free text annotation, a structured annotation, an image annotation, and a voice annotation, and generates the first annotation based on the determined type.

3. The apparatus of claim 1, wherein the processor determines a position of a frame in the media data at which the first annotation is to be included and generates the first annotation based on the determined position.

4. The apparatus of claim 1, wherein the interface is one of a motion recognition interface, a voice recognition interface, an environment sensor interface, an authoring tool interface, a media playback interface, and an automatic media based sensory effect (MSE) extraction interface.

5. The apparatus of claim 1, wherein, when a second annotation of a sensory effect is verified to be present in the media data, the acquisition unit extracts the second annotation from the media data, and
wherein the processor analyzes a sensory effect corresponding to the extracted second annotation and generates sensory effect metadata based on an attribute value of the analyzed sensory effect.

6. The apparatus of claim 5, wherein the processor analyzes a type of the extracted second annotation and analyzes the sensory effect based on the analyzed type of the second annotation.

7. A method of processing additional media information, the method comprising:
acquiring, when media data is input through an interface, a pattern corresponding to the input media data from a database; and
determining a sensory effect corresponding to the acquired pattern and generating a first annotation of the determined sensory effect.

8. The method of claim 7, wherein the generating comprises determining a type of the first annotation to be one of a text annotation, a free text annotation, a structured annotation, an image annotation, and a voice annotation, and generating the first annotation based on the determined type.

9. The method of claim 7, wherein the generating comprises determining a position of a frame in the media data at which the first annotation is to be included and generating the first annotation based on the determined position.

10. The method of claim 7, further comprising:
receiving the media data through one of a motion recognition interface, a voice recognition interface, an environment sensor interface, an authoring tool interface, a media playback interface, and an automatic MSE extraction interface.

11. The method of claim 7, further comprising,
extracting, when a second annotation of a sensory effect is verified to be present in the media data, the second annotation from the media data; and
analyzing a sensory effect corresponding to the extracted second annotation and generating sensory effect metadata based on an attribute value of the analyzed sensory effect.

12. The method of claim 11, further comprising:
analyzing a type of the extracted second annotation and analyzing the sensory effect based on the analyzed type of the annotation.
